(19) United States
(12) Patent Application Publication
(10) Pub. No.: US 2006/0059413 A1
(43) Pub. Date: Mar. 16, 2006

(54) Systems and methods for generating intellectual property

(76) Inventor: Bao Q. Tran, San Jose, CA (US)

Correspondence Address: TRAN & ASSOCIATES, 6768 MEADOW VISTA CT., SAN JOSE, CA, 95135, US

(21) Appl. No.: 10/938,784

(22) Filed: Sep. 10, 2004

(51) Int. Cl. G06F 17/24; G06F 17/21

(52) U.S. Cl. 715/500; 715/530

(57) ABSTRACT

Systems and methods are disclosed for checking a document by identifying all nouns and noun phrases in a portion of the document; and checking that the first occurrence of each noun or noun phrases has proper antecedent basis.

This application is related to provisional application Ser. No. 60/185,644, filed Feb. 29, 2000.

### BACKGROUND

The invention relates to systems, methods and techniques for procuring intellectual property assets.

Due to the speed at which new ideas and concepts propagates, businesses typically protect new concepts and technology through patent and other intellectual property (IP) law. A patent is obtained by filing an application with a national patent office such as the United States Patent & Trademark Office (US PTO), the Japanese Patent Office (JPO), or a regional patent office such as the European Patent Office (EPO), among others. The application must adhere to certain requirements. For example, in the US, the specification of the application must be enabling and must describe the invention “in such full, clear, concise, and exact terms as to enable any person skilled in the art . . . to make and use” the invention without undue experimentation in accordance with 35 U.S.C. § 112. The claims must particularly point out and distinctly claim what the applicant regards as the invention and must satisfy the statutory requirement that the claimed invention has utility and qualifies as patentable subject matter. Moreover, drawings may be required where necessary to understand the claimed subject matter. These drawings need to conform to specific Patent Office rules. Additionally, certain procedures (prior art submission, for example), if done properly and in a timely manner, can optimize cost, facilitate prosecution, and minimize charges of invalidity during enforcement. These exacting requirements make a patent application one of the most difficult legal document to be generated.

### SUMMARY

Systems and methods are disclosed for checking a document by identifying all nouns and noun phrases in a portion of the document; and checking that the first occurrence of each noun or noun phrases has proper antecedent basis.

Advantages of the techniques may include one or more of the following. The techniques provide an easy-to-use patent generating system for patent applicants to learn and use. The software provides visually based tools to create an intuitive environment in which a patent application may be developed. The tools are simple to use yet sophisticated in their functionality. Inventors and new patent agents/attorneys need to learn only a few basic skills and techniques about the art of patenting before they can draft complex patent applications. The system also checks the documents to be filed for errors and prepares formal documents for filing with the Patent Office. The system supports paper-based filing as well as electronic patent filing. The techniques eliminate the cost and delay of physically handling, processing and delivering patent applications. The techniques also interact with the national patent offices in preparing their transmittal information and provide real time acknowledgment of submissions. The system provides a convenient interface to different national electronic patent systems and allows the user to create an application that is compatible with the different national patent systems. The information is interchanged between the software and the various national patent systems using electronic techniques, which reduces most of the application processes conventionally conducted by a user, makes the patenting process efficient, enhances the reliability of the patenting process, and simplifies the control of operation by users.

Other advantages and features will become apparent from the following description, including the drawings and claims.

### BRIEF DESCRIPTION OF THE DRAWINGS

FIG. 1 is a diagram of an environment for processing intellectual property assets.

FIG. 2 is a flowchart illustrating a process for generating a patent application.

FIGS. 2A-2E are exemplary user interfaces.

FIGS. 3-12 are flowcharts illustrating processes in drafting an application.

### DESCRIPTION

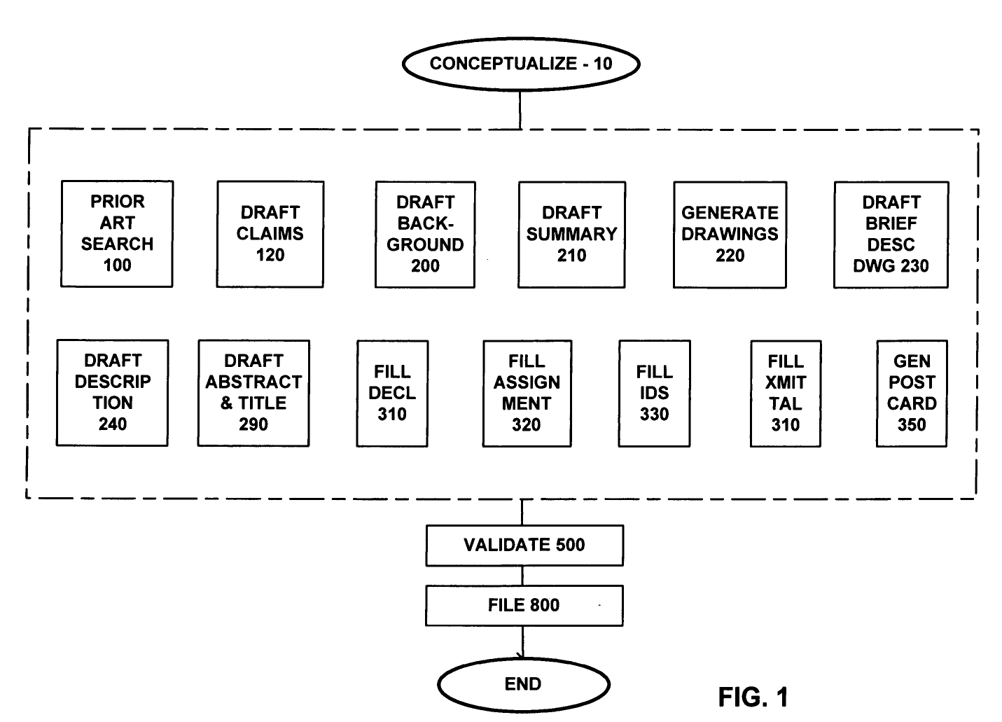

FIG. 1 shows an exemplary system for generating IP assets such as patents. First, an inventor conceptualizes a new invention (10). The inventor can reduce the invention to practice first, or the inventor can describe his/her ideas in detail in a filed patent application (constructive reduction to practice).

After conceptualization, the system of FIG. 1 provides a user such as a patent drafter with computer-aided tools to render intangible ideas into a patent application. The system allows drafting the sections in any order and supports jumping ahead to draft a latter section. Hence, a user can draft the description of the invention before drafting the claims. Writing the description first can be advantageous if the patent drafter is not intimately familiar with the invention to afford the patent drafter an opportunity to learn the invention as he or she writes the description of the invention first. In another scenario, the drafter can generate drawings before drafting claims or the description. Again, generating drawings first can be advantageous in allowing the drafter to frame the invention and to focus on the objective of his or her writing.

The tools support prior art searching (100), claim drafting (120), background section drafting (200), summary section drafting (210), drawing generating/importing (220), brief description of the drawings drafting (230), description drafting (240), abstract drafting and title drafting (290). The tools also assist the inventor in filling out formal forms that are accepted by the US PTO, including a completing a declaration form (310), an assignment/recordation form (320), and information disclosure form (330), transmittal cover and fee sheet form (310), and an acknowledgment card (350). Each of the functional tools is described in more detail below.

At any point during the drafting process, the drafter can run a diagnostic on the current section being drafted or edited. Alternatively, after a first complete draft of an application, the drafter can validate the complete draft (500). If the validation is successful, the drafter can file the patent application (800).

The system assists the user in drafting the application itself, including text discussing the field of the invention and a background discussion of the invention (including citation and discussion of prior art). The information provided in the invention disclosure can be used as a basis for the background discussion. The system guides the user in writing a summary and a brief description of the drawings. Next, the system guides the user in generating a description, which is a detailed discussion of the invention. A summary of the invention and an abstract are automatically generated based on the claims, and the user can edit the computer-generated summary of the invention and abstract if needed. The summary is separate and distinct from the abstract and is directed toward the invention rather than the disclosure as a whole. The summary may point out the advantages of the invention or how it solves problems previously existent in the art (and preferably indicated in the Background of the Invention). The process also generates formal documents such as Declaration, Assignment, and an information disclosure statement (IDS) based on the known prior art, for example.

Although the above example relates to drafting patent applications, the system of FIG. 1 can be used to prepare copyright applications and trademark applications, for example. Additionally, the system of FIG. 1 can be used to draft any complex document that requires precision and adherence to specific rules and syntax.

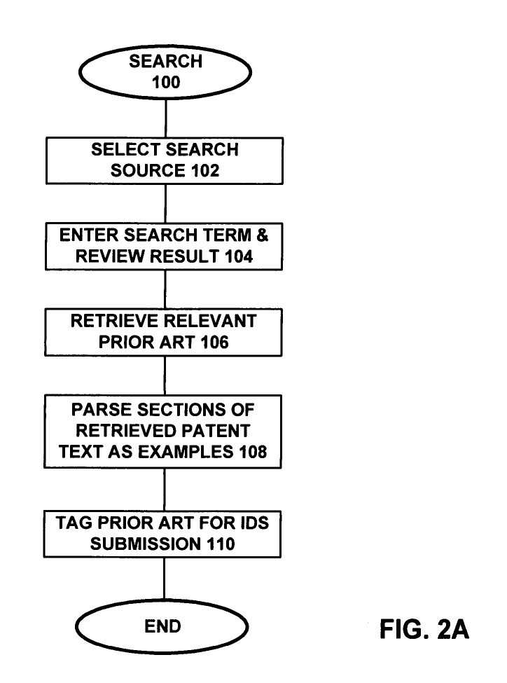

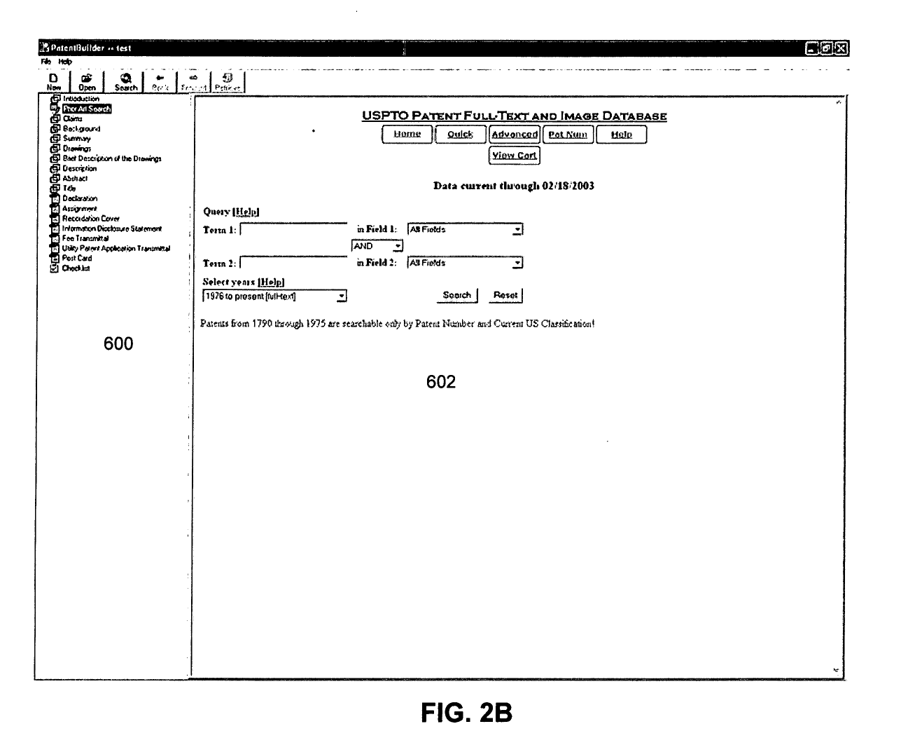

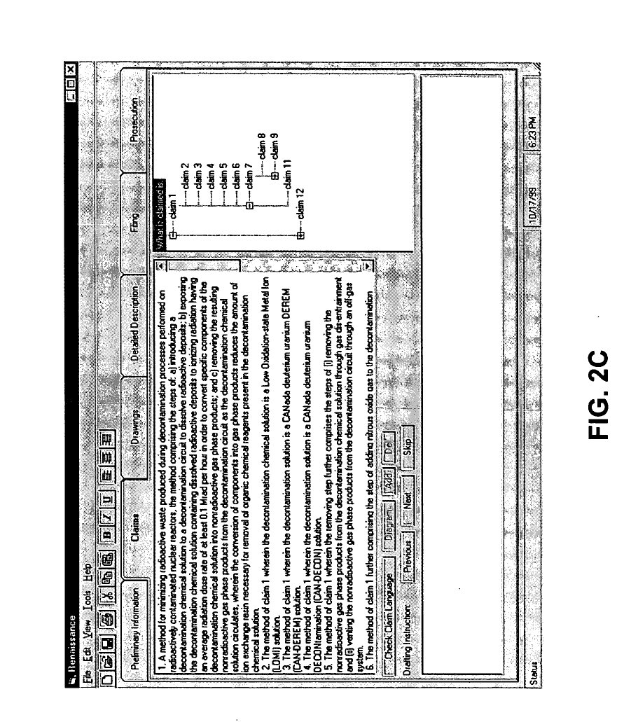

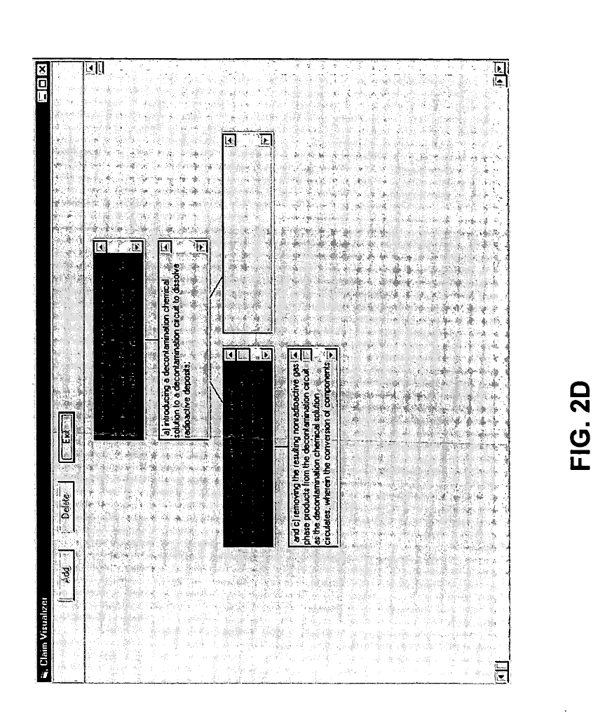

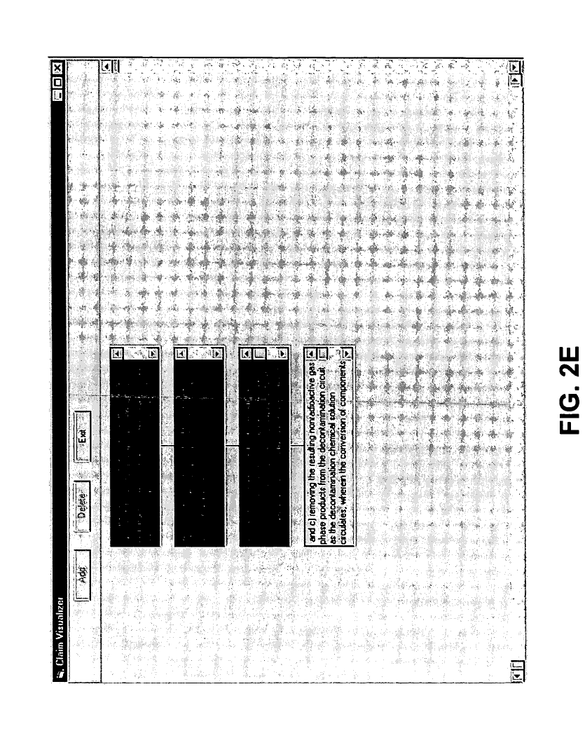

Turning now to FIG. 2, the search process 100 is discussed in more detail. The user can be prompted to first search and electronically capture the closest prior art located from the search, or if an electronic version is not available, to manually describe the closest known prior art. The closest prior art will be used to ascertain patentability and refine the scope of the claims.

In one embodiment, the user selects a search source (102). The source can include the US PTO search site, the European Patent Office search site, a commercial search site such as Westlaw, Lexis or Thomson-Delphion, or search engines such as Google, among others. Next, the user enters search term(s) and review the result of the search (104). Relevant prior art is retrieved (106). If the prior art is a patent document, actual copy of the patent can be downloaded. The process parses the retrieved text into sections and copies each parsed section into exemplary text to be displayed as examples (108). To illustrate, each US patent has a claims section, background section, summary section, brief description of the drawings section, and description section. The process parses each US patent into its relevant section and shows the section as example upon request. The process also tags the patent number, title, and other relevant information to fill out the IDS form and other forms as needed (110).

FIG. 2B shows an exemplary user interface for the search process 100. In this interface, a UI area 600 shows different tools that are available in drafting a patent application. The user may freely jump around and work on any section of the patent application at any time. When the user clicks on the Prior Art Search icon on the UI area 600, a search area 602 is displayed. In this example, the search area 602 displays the USPTO Patent Full-Text and Image Database. The user enters one or more search terms into a query and click on a Search button. A search result is returned. The user can click on one of the patents in the search result, and text from the patent is displayed for review. While the user is reviewing the prior art, a “Retrieve” button is enabled. If the patent is not relevant, the user can go to the next patent in the search result. Alternatively, if the patent is relevant prior art, the user clicks on the “Retrieve” button to download the text and to parse the text into sections that can then be displayed as examples. Additionally, if the prior art is a patent, the user can download full copy of the patent by clicking on a “Download” button.

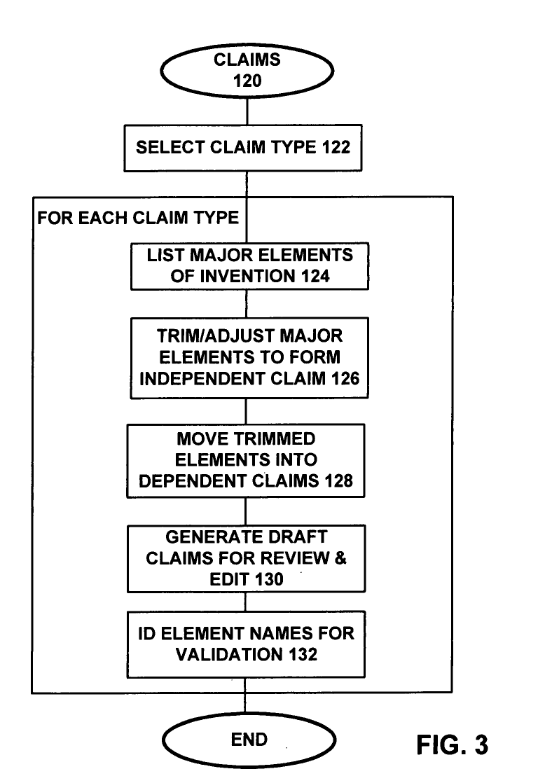

FIG. 3 shows in more detail the claim drafting process 120. Initially, the user is prompted to select a claim type (such as apparatus, method, among others) (122). The process generates a primary element list and a secondary element list. This section determines the essential elements—features, concepts, methods, or new results of the Invention, whichever is most applicable—their relationship to one another, their mode of operation, and identifies the elements considered to be novel. The primary element list will be used to construct one or more independent claims. The secondary and substitute lists will be used in generating dependent claims. The user is prompted to list major elements of the claim (124). From this list, the user is prompted to edit and tighten the list to include only elements required to distinguish the independent claim from known prior art (126). Items trimmed from the list are moved to the secondary element list to generate dependent claims (128). When the user is satisfied with the scope of the independent claim, the system automatically generates proposed claims for the user to review/edit (130). Also, element phrases are captured for subsequent validation of the claims and the description (132). Exemplary uses for the identified element phrases for claim validation include antecedent basis checking and connectivity checking. Exemplary uses for the identified element phrases can also include making sure that the element is adequately described in the specification section.

In one embodiment, the system generates the primary element list by asking the user to list only the essential elements that make the invention work and differentiate the invention from the prior art. The elements identified eventually become the elements of the claims. The primary elements are determined using an iterative process by listing all basic structures of the invention and their cooperative relationships. These elements are iteratively refined using a process of elimination to hone in on elements that differentiate the invention from the prior art. The primary elements are also refined to broaden the element from their specifics to become generic. Items that are not important in distinguishing the prior art or items that are implementation specific are moved to the secondary element list.

The system prompts the user to refine the primary elements by substituting words that broaden the element. Thus, if the element is a sub-class that can be restated as a generic term to indicate the whole class without affecting patentability, the user can restate the element as a generic term and move the narrower sub-class language into the secondary list. To illustrate, assume that in the first pass, major elements of an erasable pencil listed include: a wood housing, a carbon core, and a rubber portion. The wood housing primary element can be broadened by moving the word “wood” into the secondary element list, leaving “housing” in the primary element list. The more specific “wood” language eventually makes its way into the dependent claim as “wherein the housing comprises wood”, for example. The process can be iteratively done to refine the claim, and ideally at the end of the process, a broad claim is formed that is patentably distinctly novel over the prior art.

Next, the system generates dependent claims from the secondary element list. The system further prompts the user to expand the dependent claims. In one embodiment, dependent claims are by right clicking on a particular claim and selecting “Add Dependent Claim”. One way to supplement the dependent claims is to exhaustively list alternate ways to implement each primary element. The user can supplement the dependent claims with the features and advantages that make the invention marketable, salable, and commercially practical. The user can add the dependent claims by listing all the alternate ways to implement each primary element to block competitors from using these alternate ways to design-around the invention. The user can also claim as dependent claims unobvious ”tricks“ or special implementations not commonly done to satisfy the best mode requirement.

Once an independent claim has been drafted, the system guides the user through a series of sequence to broaden the independent claim while preserving validity over known prior art. The user is prompted to list generic alternatives for each element and uses the generic alternative in place of the specific version of the element in an independent claim, with the specific version being used in appropriate dependent claims for purposes of claim differentiation. For example, if the claim recites a “jet engine” but the invention can work with any type of engine, the system would suggest moving the specific reference “jet” to a dependent claim. The system iteratively asks the user what elements can be eliminated from a claim. For each element, the system asks the user whether this element is really necessary and can a competitor do without the element in a design around effort.

Exemplary pseudo-code for drafting an apparatus claim is as follows:

```
Generate preamble by completing the phrase: “An apparatus for
comprising:”
Form independent claim.
Generate dependent claim(s).
  Form first independent claim:
    Pick from the primary list the most important primary element.
    Select from the secondary list one or two elements that complete the
    objective listed in the preamble.
    Connect the elements together.
    Graphically show connectivity of elements.
    Check for antecedent errors.
  Form second independent picture claim:
    Copy all primary elements as claim elements.
    Connect the elements together.
    Graphically show connectivity of elements.
    Check for antecedent errors.
  Form third independent picture claim that is broadened
  from picture claim:
    Copy all primary elements as claim elements.
    Keep only strongest element that distinguishes invention
    from prior art.
    Select from the secondary list one or two elements that complete the
    objective listed in the preamble.
    Connect remaining elements together.
    Graphically show connectivity of elements.
    Check for antecedent errors.
  For each element in primary and secondary lists that is not used in
independent claim:
    Determine parent claim that current claim depends from.
    Create new claim that is below parent claim
    Renumber claims and dependencies for claims whose number are
    larger than parent claim number.
    Generate preamble by completing the phrase: “The apparatus of
    claim” + parent claim + “, further comprising”
    Generate body by adding “a” or “an” with current element.
    Connect the element by adding “coupled to said”.
    Display a list of elements in independent claim and dependent claims
    from which the current claim belongs.
    Select one element of independent claim.
    Determine if current element needs to be connected to any other
    element in independent claim and if so, connect the elements by
    adding “and coupled to said” remaining element
    in independent claim.
```

The checking of antecedent basis requires a list of nouns or noun phrases be identified from the claims and then the system can search for occurrences of each noun phrase to see if the first occurrence of the noun or noun phrase begins with “a” or “an” to satisfy the antecedent basis requirement. For cases where the user does not enter the exact phrase, the system builds a table or array of the noun/noun phrases, sort the entries, and look for substantial similarity before identifying slight variations in the phrases as being the same reference element.

The algorithm for antecedent basis checking needs to identify noun phrases. The algorithm for identifying noun phrases in one embodiment is as follows:

```
If current word is “a, an, the, said”
    Init Noun Phrase String to “”
        Get next word
    While next word is not a noun
    {
        append next word to Noun Phrase String
        get next word
    }
//while the current word is noun, add to Noun Phrase String
Append current word to Noun Phrase String
Get next word
While next word is noun
{
    append next word to Noun Phrase String
    get next word
}
```

The algorithm for identifying noun phrases in a second embodiment is described next. If current word is an element number, the process can reverse the noun phrase from the element number as follows:

```
Init Noun Phrase String to “ ”
    Get previous word
    While word is noun
    {
        append next word to Noun Phrase String
        get previous word
    }
While word is not a noun
{
    append word to Noun Phrase String
    get previous word
}
```

In another embodiment, the process looks for a number first, then saves an arbitrary number of words (for example 5 words) prior to the number. Then the process sorts all numbers encountered along with the word lists. The process matches word by word back from the number until no match. Based on the common matches, the process arrives at the element name table with corresponding element numbers. This embodiment can also work with the “a” “the” process described above.

The noun phrase algorithm is also used in the description section to identify element description that goes with each element number encountered in the description and background section for diagnostic purposes.

The process asks the user to describe a hypothetical product that, if produced, would infringe the claims. The process then helps the user in drafting one or more patentable independent claims to cover the hypothetical product in view of the prior art. The process also performs a potential infringement analysis by reading the claims onto the hypothetical accused product. If the infringement analysis indicates that the claims had been drafted too narrowly, the above process is repeated until the user is satisfied with the scope of the claims in view of the prior art.

Additionally, the system reduces the risks of a design-around as follows: with each independent claim, select the one or more elements that can be omitted from a commercial product. The user is asked to select one element (such as the least important element) and substitute an element that performs the same function but is physically as different as possible from that of the claimed element so as not to be considered an insubstantial change. The user is also asked to select the least important element and determine if the element can be changed so as to force it to function in a different way (from what is recited in either the specification or claim) while producing the same result. Based on the independent claims, the process guides the user through generating the dependent claims. This is done by iteratively asking the user about significant variations on each element of the independent claims. For example, for each independent claim, the user designates substitutes for each element for the claim.

The system helps the user in visualizing claim relationship. To move claims, the user can drag/drop claims and the claims are automatically renumbered to show their new relationship. The user can also select a claim and add new claims or delete an existing claim. The other claims are automatically adjusted and renumbered accordingly.

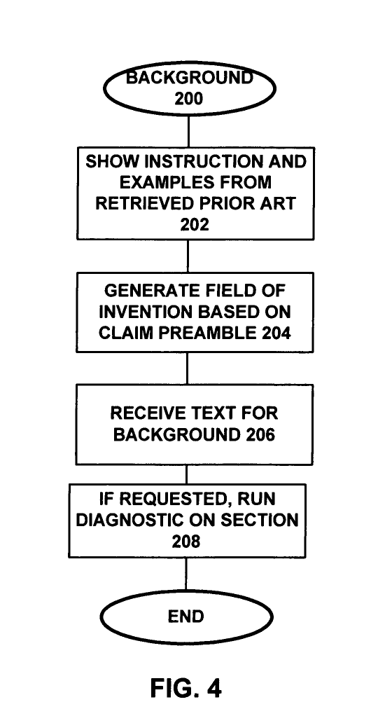

FIG. 4 shows in more detail the background drafting process 200. The process shows instruction and examples based on the prior art retrieved in FIG. 2's operation 108 (202). The instruction and examples are useful as templates for novice drafter to write his/her own background. Next, if the claims wizard has been run to generate least one independent claim, the process drafts the field of the invention based on claim 1's preamble (204). To illustrate, if the preamble of the first claim is “An apparatus for doing xyz, comprising”, the computer generated field of the invention is “The present invention relates to systems and methods for doing xyz.” The process then prompts the user to edit the field or to add text for the rest of the background section (206). If requested, the process runs diagnostics on the background section (208). For example, the system looks for derogatory words describing the prior art and warns the user to avoid denigrating the prior art.

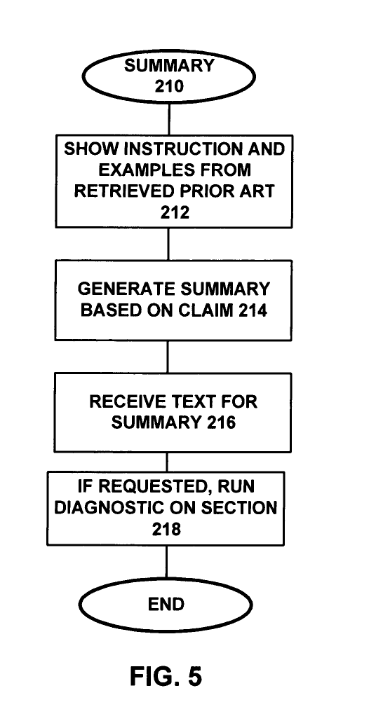

FIG. 5 shows in more detail the summary drafting process 200. The process shows instruction and examples based on the prior art retrieved in FIG. 2's operation 108 (212). The instruction and examples are useful as templates for novice drafter to write his/her own summary. Next, if the claims wizard has been run to generate least one independent claim, the process drafts the summary based on claim 1's element (214). To illustrate, if the preamble of the first claim is “An apparatus for doing xyz, comprising: x; y and z”, the computer generated field of the invention is “Systems and methods are disclosed for doing xyz.” The process then prompts the user to edit the field or to add text to the summary section (216). If requested, the process runs diagnostics on the summary section (218). For example, the system looks for derogatory words describing the prior art and warns the user to avoid denigrating the prior art.

In one embodiment, the process guides the user in drafting statements about the advantages of the invention. The system requests the user to provide a short pitch for the invention by describing the features, qualities and benefits the invention has over the existing technology. Commercial advantages for the invention should be listed, including improved performance, reduction in size/weight, increased resolution or speed, reduction in operating and/or purchase cost savings, among others. The advantages of the invention shed light on the commercial utility of a new product or service that people would want to pay for. This section can also focus on the comparative benefits over existing products to a buyer, a user, or to a manufacturer. These advantages to the buyer or user should be great enough for a company to take the risk and commit the resources necessary to commercialize the invention. The advantages portion is positioned at the end of the summary section in one embodiment.

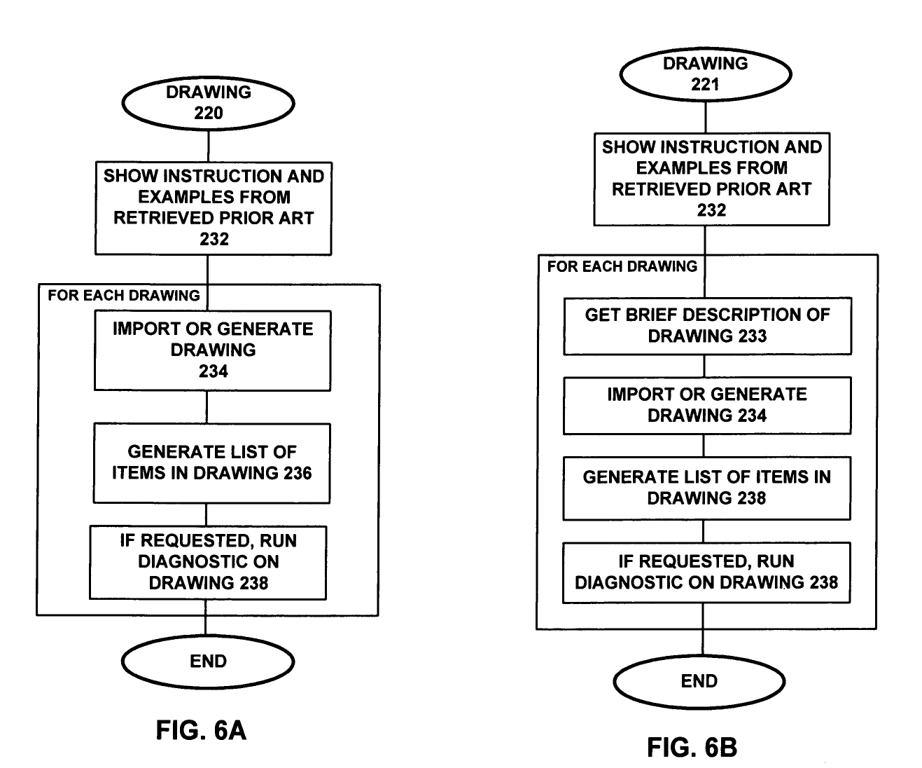

FIGS. 6A and 6B show an exemplary drawing importation process 220 and an exemplary drawing importation/annotation process 221. In FIG. 6A, the process 220 shows instruction and examples based on the prior art retrieved in FIG. 2's operation 108 (232). The example defaults to a predetermined page where drawings appear (for example pages 2 and 3 for most US patents). Next, for each drawing, the process asks the user to select a drawing to be imported (234) and a table is displayed for the user to enter names for relevant drawing items (236). If requested, the process runs diagnostics on the drawings (238). For example, the system looks for duplicate item names. In one embodiment, the system simply sorts the item number and item names and flags items that share the share item number as errors. In another embodiment, the process ensures that all elements recited in the claims are shown in the figures. This is done by comparing the claim element table against the drawing item table. If an element recited in the claim table is not in the drawing item table, the claim element is highlighted and an error message is shown.

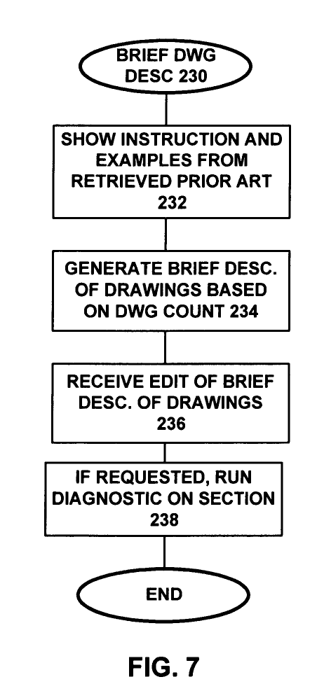

FIG. 6B is similar to FIG. 6A and thus similarly numbered items share the same description as above. The difference is that FIG. 6B asks the user for a brief description of the drawing at the same time the user imports the drawing (233). One embodiment of FIG. 6B incorporates the process of FIG. 7 in one automatic operation.

Turning now to FIG. 7, the brief description of the drawings process 230 is detailed. The brief description of the drawings is a listing of all figures by number and with corresponding statements explaining what each figure depicts. The process shows instruction and examples based on the prior art retrieved in FIG. 2's operation 108 (232). The instruction and examples are useful as templates for novice drafter to write his/her own brief description of the drawings. For each drawing imported in FIG. 6A, the process prompts the user to enter a brief description of the drawing (234). The process then prompts the user to edit the field or to add text to the brief description of the drawings section (236). If requested, the process runs diagnostics on this section (238). For example, the system looks for duplicate figure description or for deficient or excessive descriptions for the figures. If the drawings are electronic, the process can also check for conformance to drawing requirements by various Patent Office regulations such as paper margin requirements, among others.

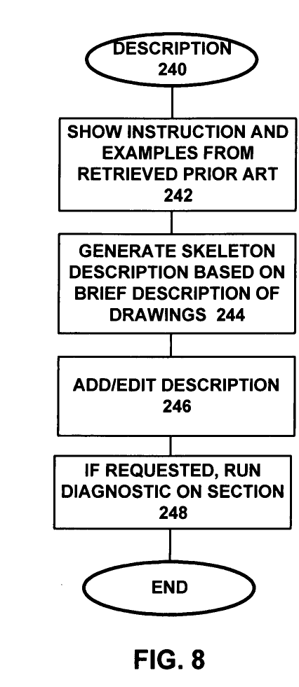

Referring now to FIG. 8, an exemplary process 240 to assist users in drafting the description section is shown. The description provides a textual description of the invention and of the drawings. In the US, the invention must be explained along with the process of making and using the invention in full, clear, concise, and exact terms. The process 240 shows instruction and examples based on the prior art retrieved in FIG. 2's operation 108 (242). The instruction and examples are useful as templates for novice drafter to write his/her own description. Next, the process drafts an outline of the description by copying the brief description of the drawings into the current section (244). The process then prompts the user to edit the field or to add text to the description section (246). If requested, the process runs diagnostics on the description section (248). In general, the description simply discusses the invention in sufficient detail so that any person of ordinary skill in the art could make and use the invention without extensive experimentation. The best mode contemplated by the inventor of carrying out the invention must be set forth in the description. Each element in the drawings should be mentioned in the description. The user should also describe any possible equivalents for each element recited in the claims. The explicit equivalent discussion in the patent application can frustrate attempts to design-around the patent using equivalent elements. In one embodiment, a process generates a description by taking the elements of each figure, ascertaining the relationships among the elements, and textually describes the elements in the figures. The process selects a figure to describe. The process then determines various related groups of elements to focus on, one at a time. For each related group of elements in the figure, the process identifies each element in the related group and extract name of element and relationship to other element(s) in the figure. This information is translated into text form. Reference characters corresponding to elements recited in the detailed description and the drawings are used in conjunction with the recitation of the same element or group of elements in the claims. The reference characters are enclosed within parentheses so as to avoid confusion with other numbers or characters that may appear in the claims. The process also textually describes the operation of element and relationship of element to other element(s). The process then textually describes the operation of the group of elements in combination so that a reader can have a bird's eye view of the element's role. Further, the process also prompts the user to provide an overview description of all elements in the figure at the end of the description for the figure to package the description in clear and easy to read language. Additionally, the process checks to ensure that all elements recited in the claims are described in the description section. This is done by searching each entry in the element table for each claim against the description generated. If one or more elements recited in the claims are not shown in the description, the claim element is highlighted and an error message is shown before the process allows the user to update the figures. The process also prompts the user to confirm that the specification includes adequate written description of the invention or discovery and of the manner and process of making and using the same, and is required to be in such full, clear, concise, and exact terms as to enable any person skilled in the art or science to which the invention or discovery appertains, or with which it is most nearly connected, to make and use the same. This is necessary since the specification must set forth the precise invention for which a patent is solicited, in such manner as to distinguish it from other inventions and from what is old. It must describe completely a specific embodiment of the process, machine, manufacture, composition of matter or improvement invented, and must explain the mode of operation or principle whenever applicable.

The process also prompts the user to ensure that the best mode contemplated by the inventor of carrying out his invention has been described. The process also prompts the user that the specification must particularly point out the part or parts of the process, machine, manufacture, or composition of matter to which the improvement relates, and the description should be confined to the specific improvement and to such parts as necessarily cooperate with it or as may be necessary to a complete understanding or description of it.

Pseudo code for one embodiment to generate the description is:

```
For all Figures
  Select next Figure
  For each related group of elements in the Figure
    For each element in the related group
      Extract name of element and relationship to other element(s) in the
    Figure.
      Textually describe the operation of element and relationship of
    element to other element(s).
    Next
  Textually describe the operation of the group of elements
  in combination.
  Next
  Textually describe the operation of the figure as a whole.
Next
Check for conformance to claim language and description requirements.
```

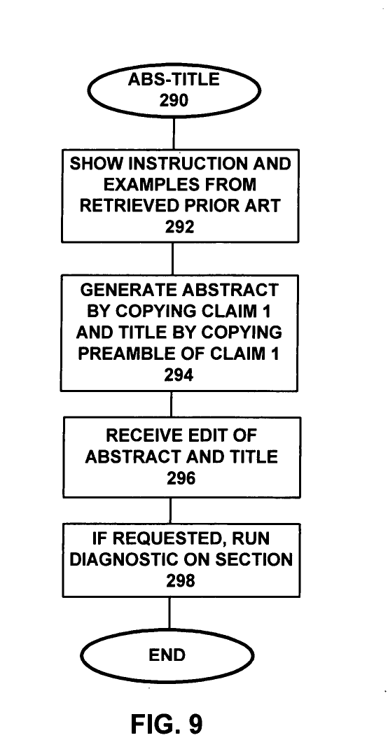

Turning now to FIG. 9, a process 290 that assists users in drafting the abstract section and the title section is shown. The process shows instruction and examples based on the prior art retrieved in FIG. 2's operation 108 (292). Next, if the claims wizard has been run to generate least one independent claim, the process drafts the abstract based on claim 1's elements (294). In one embodiment, if the summary section has been completed, the process simply copies the first paragraph of the summary section. The process then prompts the user to edit the field or to add text to the abstract section (296). The above operations are also performed for the title section. If requested, the process runs diagnostics on the abstract/title section (298). For example, the system checks whether the user has exceeded the allowable length for the abstract and the title.

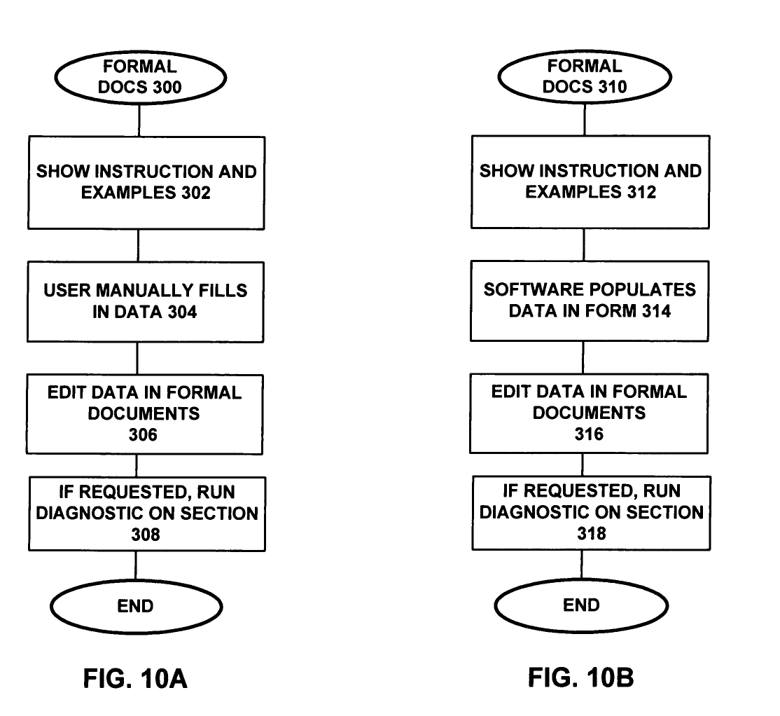

Turning now to FIGS. 10A and 10B, exemplary processes 300 and 310 for completing formal documents associated with a patent application filing are shown. Processes 300 and 310 differ as to whether the user manually enters the information into a form or whether a computer automatically populates the fields in the form. In FIG. 10A, the manual approach is illustrated. First, instructions/examples are shown (302). Next, the user is prompted to manually fill in the required information (304). The user can edit the information (306). If requested, the system performs basic diagnostic on consistency of the information typed into the forms (308). FIG. 10B is similar, except that software populates the data at 314.

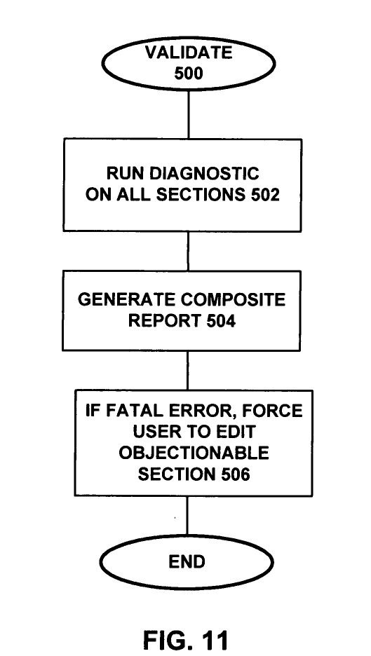

FIG. 11 shows an exemplary validation process 500. This is typically requested prior to printing the final version of the application. First, the process runs all diagnostic software for all sections (502). Next, a composite report is generated (504). If a severe error occurs, the process forces the user to confront the offending text (506).

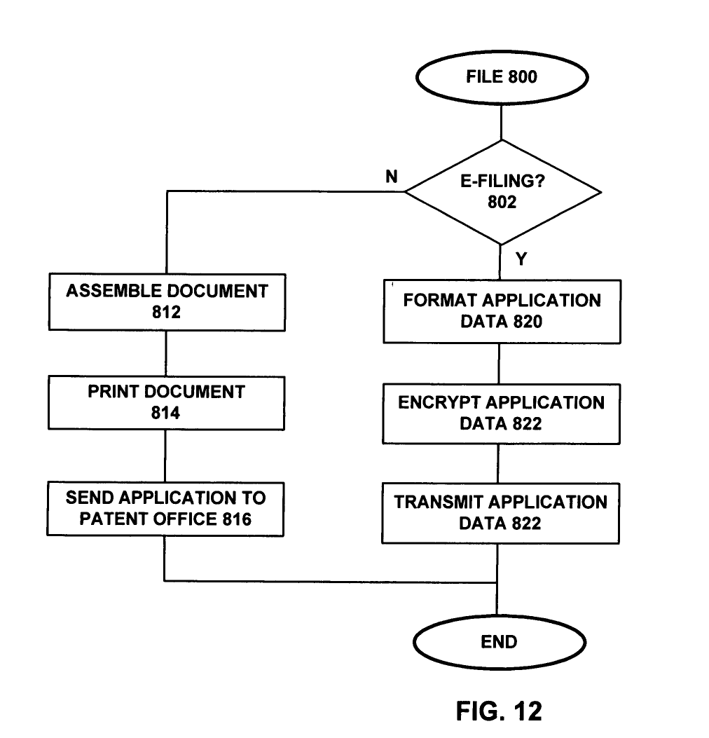

FIG. 12 shows an exemplary filing process 800. First, the process determines whether electronic filing is to be done (802). If not, the process assembles the patent application papers (812) and prints them (814). The process then prints out a check list and post-card, for example, and ask the user to perform a final review prior to putting the documents in an envelope for filing (816).

In one embodiment, the process assembles the draft application in accordance with a predetermined order of arrangement: Title of the invention; Cross-reference to related applications; Statement regarding federally sponsored research or development; Reference to a “Microfiche appendix”; Background of the invention, including a Field of the invention and a Description of related art; Brief summary of the invention; Brief description of the several views of the drawing; Detailed description of the invention; Claims; Abstract of the Disclosure; Drawings; and Sequence Listing (if any). The process guides the user through a detailed pre-filing check that eliminates common filing mistakes. For example, the pre-filing check verifies that the Express Mail Declaration includes correct Mailing Label Number and Express Mail Mailing Label stub or sticker is attached to the Declaration; Postcard includes Express Mail Mailing Label Number and lists all papers being sent and the pages of each; Check for filing fee attached or deposit account charged on transmittal letter; Transmittal letter is complete and accurate, names all known inventors and includes Express Mail stamp; Cover sheet includes title, names of inventors, and Express Mail stamp; All pages are present and checked for printer errors, and all pasted in tables and handwritten symbols are included; At least one claim is included; Appendices, if any, include all pages and cover sheets of each include an Express Mail stamp; Microfiche appendix, if any, is referenced at start of specification; Declaration is signed and if not signed, warn the user that surcharge will be assessed and signed Declaration will be required within 3 months; All figures are included and checked against the list of figures in the specification; Figure stamp appears on back of all sheets; Assignment, if filed, is complete and includes Recordation Cover Sheet; Check for assignment fee is attached; Small Entity Declaration, if qualify, is signed by proper company officer or inventor; Foreign priority documents are enclosed to perfect the claim for priority; IDS, if included, lists all art cited by the applicant or examiner in any related application and any new art; Copies of all the art are included; and Transmittal letter includes Express Mail stamps with correct mailing label number, among others.

From 802, if e-filing is to be done, the process formats the application data (820). The data is then encrypted to ensure its confidentiality (822). The application is then electronically transmitted to a server at a national patent office (824). In one implementation, the system communicates with an electronic Packaging and Validation Engine (ePAVE,) developed by the US PTO to provide its customers with a means to enter transmittal and fee information, bundle it with the application's Declaration and Specification, compress the package, and transmit it to the agency. To address the confidentially and integrity of the information as it is being transmitted over the Internet, the system conforms to the US PTO's Public Key Infrastructure (PKI) software to digitally sign and encrypt the information. Although the US PTO is mentioned as an example, other suitable patent offices include regional patent offices such as the European Patent Office and national patent offices such as the Japanese Patent Office, among others.

In one embodiment, the system provides an on-line assistant in the form of an electronic agent. In one implementation, the agent character is Merlin, available from Microsoft. For new users who were not sure of how to proceed, Merlin would guide them in a more reassuring manner. The script for Merlin is reproduced below to provide more user assistance.:

PBMerlin.msh (MASH type file that is downloadable at http://www.bellcraft.com/mash/)
[MASH Script]
Version = 5.6
[Characters]
Merlin = Merlin.acs
[LanguageIDs]
Merlin = &H409
[Script]
Merlin.Show
Merlin.Speak “Welcome to Patent Builder. My name is Merlin and I am here to guide you through
the process of protecting your invention using the U.S. patent system.”
Merlin.Speak “A U.S. patent for an invention is the grant of a property right to the inventor(s),
issued by the U.S. Patent and Trademark Office. The right conferred by the patent grant is, in the
language of the statute and of the grant itself, “the right to exclude others from making, using,
offering for sale, or selling” the invention in the United States or “importing” the invention into the
United States. To get a U.S. patent, an application must be filed in the U.S. Patent and
Trademark Office.”
Merlin.Speak “Although PatentBuilder is designed to help you generate professional quality
patent applications, it is not intended to replace attorneys. You should get legal advice from a
registered patent attorney to ensure that you get the maximum coverage afforded you by the law.
For a list of patent attorneys, you can select an attorney from the Attorney Directory by clicking on
the ‘Attorney’ menu.”
Merlin.Speak “The PatentBuilder window is divided into three main areas: Task Explorer, Data
Entry section, and a Multi-Function section that contains Instructions, Dynamically Generated
Examples, and User Notes. All of these areas can be sized to your preference by clicking on and
dragging the divider bars between them.”
Merlin.Speak “The Task Explorer is the area of the application that contains a list of tasks to be
done that is arranged in a logical order in completing a patent application. This order is followed
when you click the “Next” and “Previous”
buttons. However, you can move around all tasks and view the tasks in a non-linear manner.”
Merlin.Speak “The lower half of the PatentBuilder window is the Multi-Function Information
Screen that contains Instructions, Dynamically Generated Examples, and User Notes. The user
can hit on the “Instruction” tab to view a context sensitive set of instructions for completing the
current task. The user can also click the Examples tab to view a context sensitive illustration
based only on a relevant portion of the prior art in order of the proximity of the prior art to the
invention being applied for. The Multi-Function Information Screen provides in-depth assistance
to help a beginner to complete the current section.”
Merlin.Speak “The upper half of the PatentBuilder window is the Data Entry section.”
Merlin.Speak “The Data Entry screen captures text entry from you relating to your application.
This is the area where most of your work will be done. You can type the application in this box
with the assistance of the Task Explorer and the Multi-Function Information Screen. The Task
Explorer tells the user where he or she is relative to the rest of the application drafting process.
The Multi-Function Information screen provides the user with instructions, examples to follow, and
notes that the user can enter for each step to remind the user of things that need to be done.
When you become more experienced with writing patent applications, you may wish to close the
Multi-Function Information Screen to maximize your work space.”
Merlin.Speak “If you would like instructions, just click the Instruction button. If you need
example(s), click on the Example button. To navigate to and from different screens, click on the
Left or Right buttons, respectively.”
Merlin.Speak “Now let's get to work.”
Merlin.Play “DoMagic1”
Merlin.Speak “The major activities in drafting a patent application are (1) searching and reviewing
the prior art; (2) generating drawings illustrating embodiments of the invention; (3) drafting claims,
background, brief description of the drawings, and detailed description; and (4) filling out forms
(declaration, assignment, information disclosure statement, fee calculation sheet, cover sheet,
acknowledgement postcard and a checklist).”
Merlin.Speak “First, let's go to an on-line patent facility. Click on the PTO button to search for
patent prior art at the US Patent and Trademark Office (USPTO) or the EPO button to search at
the European Patent Office (EPO).”
Merlin.Speak“Please enter keyword(s) describing your invention in the search fields and click the
Search button”
Merlin.Play “search”
Merlin.Speak “Next, please click on each prior art and review.”
Merlin.Play “Read”
Merlin.Speak “If you determine that the current prior art is relevant to your invention, you can
click on the <Retrieve Prior Art> button to retrieve this prior art for subsequent review.”
Merlin.Play “Think”
Merlin.Speak “Now, let's summarize the main difference between known prior art and your
invention. If the prior art is identical or very similar to your invention, your invention may not be
patentable.”
Merlin.Play “Write”
Merlin.Speak “Now that you have an idea of the prior art, we can focus on generating valid
claims. Two common types of claims are method claims and apparatus claims. We will focus on
the method claims first.”
Merlin.Play “RestPose”
Merlin.Speak “Method claims are commonly thought of as a series of functions or processes that
are carried out by the invention. Can you think of high level steps or processes performed in your
invention that have at least one patentably distinct function or process?”
Merlin.Play “LookUp”
Merlin.Speak “Please list primary processes or functions performed by the invention. The first
word of each process or function is a gerund, or ends in ‘ing’ (such as calculating, determining,
compressing,..). Please stay at a high level when describing these functions at this time
(implementation specific processes or functions will be addressed next). Click <Add> button to
add a new primary process in the table.”
Merlin.Play “LookUpReturn”
Merlin.Speak “Please review the wordings to make sure they are as generic and broad as
possible (for example, reciting the function of compressing video data is broader than reciting the
function of performing MPEG compression. Click <Next> when you have completed and edited
wording in the list.”
Merlin.Speak “A checkbox has been added next to each element entered. Please review the list
and check off as few elements as possible that define the invention and still retain at least one
non-obvious difference over the known prior art way of providing the method. Click <Next> when
you are done. If you need to add a new primary process or function, click <Back> button to go
back to the previous screen.”
Merlin.Play “Write”
Merlin.Speak “A sample independent method claim has been sketched. Please review the
wording of the claim to make sure they are as generic and broad as possible. If this is not the
case, please go back to the screen listing the primary processes of the invention and update the
wording in that screen and restart the process.”
Merlin.Play “Think”
Merlin.Speak “If this claim defines your invention in the broadest possible manner and still
distinguishes over the prior art, please click <Save>. Otherwise, please click <Back> to select
different elements from your primary process table to draft a new independent claim. Click
<Next> to work on dependent claims.”
Merlin.Play “Process”
Merlin.Speak “Sample dependent claims has been generated based on the secondary process
table. Please edit the draft dependent claims if necessary and click <Save> when done.
Otherwise, please click <Back> to edit the secondary process table. Click <Next> to complete
this portion of the patent drafting process.”
Merlin.Speak “Let's check your claims. We will check for antecedent basis problems.”
Merlin.Speak “Do you wish to generate another set of method claims? If so, click on <Generate
New Set>. Otherwise, click <Next>”
Merlin.Speak “We will repeat the claim generation process for apparatus claims”
Merlin.Speak “Apparatus claims are claims that cover structures making up the invention. Can
you think in high level structures that make up your invention that have at least one patentably
distinct feature?”
Merlin.Play “LookUp”
Merlin.Speak “Please list primary structures of the invention. Please stay at a high level when
describing these structures at this time (implementation specific structures will be addressed
next). Click <Add> button to add a new primary process in the table.”
Merlin.Play “LookUpReturn”
Merlin.Speak “Please review the wordings to make sure they are as generic and broad as
possible (for example, reciting the structure of computer is broader than reciting mainframe,
which is a type of computer. Click <Next> when you have completed and edited wording in the
list.”
Merlin.Speak “Please review the list and check as few elements as possible that define the
invention and still retain at least one non-obvious difference over the known prior art way of
providing the method. Click <Next> when you are done. If you need to add a new primary
process or function, click <Back> button to go back to the previous screen.”
Merlin.Play “Write”
Merlin.Speak “A sample independent apparatus claim has been sketched. Please review the
wording of the claim to make sure they are as generic and broad as possible. If this is not the
case, please go back to the screen listing the primary structural elements of the invention and
update the wording in that screen and restart the process.”
Merlin.Play “Think”
Merlin.Speak “If this claim defines your invention in the broadest possible manner and still
distinguishes over the prior art, please click <Save>. Otherwise, please click <Back> to select
different elements from your primary process table to draft a new independent claim. Click
<Next> to work on dependent claims.”
Merlin.Play “Process”
Merlin.Speak “Sample dependent claims has been generated based on the secondary process
table. Please edit the draft dependent claims if necessary and click <Save> when done.
Otherwise, please click <Back> to edit the secondary process table. Click <Next> to complete
this portion of the patent drafting process.”
Merlin.Speak “Let's check your claims. We will check for antecedent basis problems and
structural connectivity problems.”
Merlin.Speak “Do you wish to generate another set of apparatus claims? If so, click on
<Generate New Set>. Otherwise, click <Next>”
Merlin.Play “Congratulate_2”
Merlin.Speak “We are now done with the claims. The rest is easy now.”
Merlin.Play “Pleased”
Merlin.Speak “Let's develop a title for the application. One style of naming an application is to
mirror the preamble of the broadest method and apparatus claims. Thus, if you have both
apparatus and method claims, one title can be ‘APPARATUS AND METHODS FOR ...’”
Merlin.Speak “Please enter a title for the application now. It should be brief but technically
accurate and descriptive preferably from two to seven words.”
Merlin.Speak “Do you have any related applications that you would like to claim priority to? If so,
please enter the serial number, the filing date, the title, and inventorship for each application that
you are claiming priority to and enter that information in the box.”
Merlin.Speak “If the invention was developed as part of a federally sponsored research or
development, please click the <Federally Sponsored R&D> button.”
Merlin.Speak “If you have a microfiche (typically of software source listing) that you want to attach
as an appendix, please click the <Microfiche Appendix> button and enter the total number of
microfiche and total number of
frames.”
Merlin.Speak “Turning now to the Background Section, The first section is the Field of the
Invention. This section should include a statement of the field of endeavor to which the invention
pertains. This section may also include a paraphrasing of the applicable U.S. patent Classification
Definitions or the subject matter of the claimed invention.”
Merlin.Speak “One school of thought is to copy the preamble of the claims as the field of the
invention. There are other styles as well.”
Merlin.Speak “Now let's draft the Field of the Invention.”
Merlin.Speak “Turning now to the Description of Related Art section, this section should contain a
description of background information, including references to specific problems involved in the
prior art (or state of technology) that are solved by your invention.”
Merlin.Speak “Now let's draft the Background.”
Merlin.Speak “Let's draft the Summary and Abstract”
Merlin.Speak “The summary should track the language of the broadest claim. Hence, please
copy the broadest independent claim here and edit the language for readability. This edited
language will also become the Abstract.”
Merlin.Speak “Next, let's generate drawings or import drawings illustrating embodiments of the
invention.”
Merlin.Speak “Click on the Import button if you wish to import a Visio file or a Power Point file
containing drawing(s). Click on the Scan button to capture bitmaps of the drawing(s). Click on
the Draw button to sketch drawing(s).”
Merlin.Play “Write”
Merlin.Speak “Please annotate each element in the drawing with a number or alphanumeric
identifier.”
Merlin.Play “WriteContinued”
Merlin.Speak “For each element number or alphanumeric identifier, please enter a corresponding
textual description.”
Merlin.Play “WriteReturn”
Merlin.Speak “Let's draft the Brief Description of the Drawings.”
Merlin.Speak “For each Drawing, please complete the sentence: Figure_shows a ...”
Merlin.Speak “Referring now to the Description section, the invention must be explained along
with the process of making and using the invention in full, clear, concise, and exact terms. This
section should distinguish the invention from other inventions and from what is old; and describe
completely the process, machine, manufacture, composition of matter, or improvement invented.
In the case of an improvement, the description should be confined to the specific improvement
and to the parts which necessarily cooperate with it or which are necessary to completely
understand the invention. It is required that the description be sufficient so that any person of
ordinary skill in the pertinent art, science, or area could make and use the invention without
extensive experimentation. The best mode contemplated by you of carrying out your invention
must be set forth in the description.”
Merlin.Play “Write”
Merlin.Speak “Let's check your application so far for potential problems.”
Merlin.Speak “Each element in the drawings should be mentioned in the Description. Let's
compare your numbered elements in the tables against the drawings.”
Merlin.Speak “Each element recited in the claims should be mentioned in the Description. Let's
compare your claim language against the text of the Description.”
Merlin.Speak “Congratulations, you have completed the application. Now we need to complete
formal documents such as the Fee Transmittal, the Utility Patent Application Transmittal, the
Declaration and optionally, the Assignment, the Assignment Recordation, and an Information
Disclosure Statement.”
Merlin.Speak “Let's fill out the Fee Transmittal.”
Merlin.Speak “Let's fill out the Utility Patent Application Transmittal.”
Merlin.Speak “The applicant shall make oath that he believes himself to be the original and first
inventor of the process, machine, manufacture, or composition of matter, or improvement thereof,
for which he solicits a patent; and shall state of what country he is a citizen. Now, let's fill out the
Declaration”
Merlin.Speak “Applications for patent, patents, or any interest therein, cab be assignable in law
by an instrument in writing. The applicant, patentee, or his assigns or legal representatives may in
like manner grant and convey an exclusive right under his application for patent, or patents, to the
whole or any specified part of the United States.”
Merlin.Speak “If applicable, you and your co-inventors (if any) can fill out the Assignment and the
Recordation Cover Page. Otherwise you can click on <Next> to skip working on the Assignment
and the Recordation Cover.”
Merlin.Speak “The law imposes a duty of disclosure if you are aware of relevant prior art. If you
have relevant prior art to be submitted to the Patent Office, please fill out the Information
Disclosure Statement.”
Merlin.Speak “We are almost done. Now let's fill out an acknowledgement receipt card. The
Patent Office mails you this card back to you to acknowledge that they have received an
application from you.”
Merlin.Speak “Please spend a moment reviewing the accuracy of the application before we
generate a Word document and print your application. If you are satisfied, please click on
<Proceed> to generate the application.”
Merlin.Speak “Let's carefully review the checklist before we drop the application in the mail.
Please check off every check box provided. If you need to correct the application, please click on
<Back> until you get back to the place where you can correct the document.”
Merlin.Speak “Congratulations. You have completed the application. Once the Patent Office
receives the application, your invention acquires the patent-pending status.”
[Commands]
MenuName = My Menu Name
ACO = Advanced Character Options|˜|Advanced Character Options
[CommandScript:ACO]
AgentControl.PropertySheet.Visible = True

In another embodiment, the patent system is embedded in a word processor such as Microsoft Word or Corel WordPerfect. A new menu is added:

```
Draft Patent
    Check Application
    Claim Tool
Report
    Print
    Save As...
```

When the user selects “Check Application”, the system “Check Brief Description of Figures” by verifying that each Figure mentioned in this section is mentioned at least once in the Background or the Description. In reverse, verify that each Figure mentioned in the Description or Background is reflected in the Brief Description of Figures section. (Figure=Fig. and Figures=Figs). Next, the system check claims by analyzing claim dependency. The system also identifies each noun phrase in the claim and check to see if the noun phrase is mentioned at least once in the rest of the document text (outside of the Claim Section). The system also performs an antecedent basis check. The system verifies that the same item text in the entire document text does not refer to 2 different numbers and checks that word count for Abstract is less than 250 words and Abstract is only one paragraph. A Claim Tool is provided where, from text of all claims, an explorer list is generated showing claims and independent/dependent relationship. The system allows users to add/delete claims graphically. When the user clicks on Save, regenerate Claim list as Word text. The user can pick between printing reports or saving the report to a file.

Although the above system is stand-alone, the system can also be networked. In such a system, a server is connected to a network such as the Internet. One or more client workstations are also connected to the network. Additionally, an Internet community with one or more service providers, manufacturers, or marketers is connected to the network and can communicate directly with users of the client workstations or indirectly through the server. The Internet community provides the client workstations with access to a network of IP specialists. For example, members of the Internet community can include attorneys who can add value to the preparation, the prosecution, and the enforcement of the resulting IP rights. Additionally, the Internet community also provides access to a variety of supporting members such as prior art search firms and patent delivery firms, among others. Additionally, one or more patent granting authorities such as the US PTO, the Japanese Patent Office, and the European Patent Office, among others, can be connected to the network. The patent granting authorities can receive electronic patent application submissions and can also provide various resources aiding patent applicants. Yet another service supported by the portal is on-line trading of IP assets. By communicating through a wide area network such as the Internet, the portal supports a network-based community in which buyers and sellers are brought together in an efficient format to buy and sell intellectual property and other assets. The portal permits sellers to list assets for sale, buyers to bid on assets of interest and all users to browse through listed items in a fully-automated, topically-arranged, intuitive and easy-to-use online service that is available 24-hours-a-day, seven-days-a-week. Through such an IP trading portal, IP buyers can access a significantly broader selection of IP assets to purchase and sellers have the opportunity to sell their IP assets efficiently to a broader base of buyers. The portal overcomes the inefficiencies associated with traditional person-to-person trading by facilitating buyers and sellers meeting, listing items for sale, exchanging information, interacting with each other and, ultimately, consummating transactions. The portal helps the user protect new ideas or concepts in an economical, efficient and fast manner by providing the user with access to a network of IP lawyers for assistance in finalizing the applications. The portal also links the user with IP related businesses such as those who specialize in trading or mediating IP related issues. The portal also provides access to non-IP resources, including venture capitalists and analysts who track evolving competition and market places. The portal remains with users the entire time they are online and can automatically update the users on any competing products or any new patents or trademarks granted in their areas of interest. Once users are logged-in, the portal remains in full view throughout the session, including when they are waiting for pages to download, navigating the Internet and even engaging in non-browsing activities such as sending or receiving e-mail. The constant visibility of the portal allows advertisements to be displayed for a predetermined period of time. Thus, the techniques provide Internet advertisers and direct marketers a number of advantages in realizing the full potential of online advertising. The techniques capture the users' profiles regarding their areas of interests, current occupations, company affiliations, demographic information (such as age, gender, income, geographic location and personal interests), and the users' behavior when they are online with the system. As a result, the system can deliver targeted advertisements based on information provided by users, actual Web sites visited, Web-site being viewed, or a combination of this information, and measure their effectiveness. Thus, the system allows online advertisers to successfully target their audiences, largely due to the availability of a precise demographic and navigation data on users. The system also allows advertisers to receive real-time feedback and capitalize on other potential advantages of online advertising. The techniques also support purchasing or selling intellectual property related products and services with a computerized bid, auction and sale system over a network such as the Internet. The techniques provide IP owners with access to an open market for trading IP. The techniques support a service-based auction network of branded, online auctions to individuals, businesses, or business units. The techniques offer a quick-to-market, flexible business model that can be customized to fit the IP needs of any industry and target technology. On-line trading is done through a network-based community in which buyers and sellers are brought together in an efficient format to buy and sell intellectual property and other assets. The system permits sellers to list assets for sale, buyers to bid on assets of interest and all users to browse through listed items in a fully-automated, topically-arranged, intuitive and easy-to-use online service that is available 24-hours-a-day, seven-days-a-week. The system overcomes the inefficiencies associated with traditional person-to-person trading by facilitating buyers and sellers meeting, listing items for sale, exchanging information, interacting with each other and, ultimately, consummating transactions. Through such a trading place, buyers can access a significantly broader selection of assets to purchase and sellers have the opportunity to sell their assets efficiently to a broader base of buyers. The techniques support real time and interactive auctions that allows bidders place bids in real time and compete with other bidders around the world using the Internet. The techniques allow customer bids to be automatically increased as necessary up to the maximum amount specified, so bids can be raised and auctions won even when bidders are away from their computers.

Although the above systems and processes are geared toward patents, the system can process applications for copyrights and trademarks. In one embodiment for generating software copyright applications, the system selects and displays an appropriate form such as a Form TX from the Copyright Office. Databases are generally considered to be literary works, and are also registered using Form TX. If the database is continually updated, it may be considered a serial work, whose registration should be completed using Form SE. If pictorial images and accompanying sounds are dominant over the text therein, the application should be registered as an audiovisual work, using Form PA. The system then walks the user through each section of the application. For Form TX, the system prompts the user to enter a title, which is the name of the work that the Copyright Office will use for indexing purposes, and for future identification. Here, each program will need its own title and, optionally, a version number. If the version number is other than 1.0, an examiner may allow only the additions over the earlier, but non-copyrighted, versions. If the software is known by any other titles in a previous version, then that information must be filled into the space for the block labeled Previous or Alternative Titles. Further, in cases where the work is a contribution to a periodical, serial or collection, the collective work must also be identified. The system then guides the user in Section 2 of Form TX, where the author or authors are identified. If the work was made for hire, then the hiring party is the author. If not, the person who actually wrote the program is the author. If the work-for-hire box is checked, the employer should be identified as the author. The author's birth date is required, where an individual is the author, but is not required if the software is a work-for-hire. If the author is deceased, the year of death must be included. Finally, the nationality or domicile of the author is needed. Further, a brief description of the work must be entered in the space labeled “Nature of Authorship.” For computer programs, the user is prompted to broadly state the description. The following provides a list of examples: computer program, entire computer code, entire program, entire program code, entire text, entire work, module, program, program instructions, program listing, program text, revised program, routine, subroutine, software, and text of program. The system then prompts the user to fill Section 3, which asks for the creation date, or the date that the work was first fixed in some medium, and the publication date, or the date of first distribution (or offer of distribution), public performance, or public display. Similarly, Section 4 asks for the names and addresses of each claimant, which can be the author, or a person or organization who has ownership interests in the work. If the claimant is not the author, a brief statement explaining the chain of ownership should be given. This statement can be as simple as “By written contract,” “Transfer of all rights by author,” or “Assignment.” The application need not include transfer documents or riders to support the statement. The user is guided on to Section 5, which asks for the date of the latest prior registration of the work and (assuming the identical work has already been registered) the basis for the subsequent application. If the same version has already been registered, a subsequent registration may be used to correct authorship, or where the work was originally registered in an unpublished version, a subsequent registration can be sought for the published version. Next, the system provides a menu for the user to determine if the work being registered is a changed version, a compilation, or a derivative work. In Section 6, the system presents the user with choices along with explanation on the choices, including “Previous Version,” “Revised Computer Program,” or “Revisions and Additional Text of Computer Programs.” If the work is both a derivative work and a compilation, the system prompts the user to state “Compilation and Additional New Materials.” Further, the system prompts the user to provide a deposit material. For a computer program, the deposit material must be in some visually perceivable form. Where the program has not been published (or if the program has been published only in machine readable form) one complete copy of “identifying portions” of the program must be reproduced on paper or microfilm. If published, 2 copies of the program must be submitted. Generally, an identifying portion consists of the first and last 25 pages (or equivalent units of source code) if printed on paper, plus the page containing the copyright notice. Alternatively, if the program is less than 50 pages, the whole program listing can be deposited.

Similarly, for trademark applications, another embodiment can walk the user through whether he or she wishes to generate use-based applications or intent-to-use (ITU) applications, which are available if one has not yet used the mark on goods. The system prompts the user to list all the goods with which the mark will be used, or has been used. This should be carefully worded to ensure that the registration is not unduly narrowed. The system then requests a description of how the mark is used. A trademark must be used on (or in connection with) the actual goods—advertising is not sufficient use. The system can ask if the mark is a composite mark (such as a logo plus words), then the system presents the user with a choice of registering the word mark alone, the word/logo combination, or the logo alone. The system also guides the user with the selection of specimens with a use application. These are actual labels, tags, or packaging. The system can then suggest alternatives such as photographs that can be sent instead of specimens when the specimen is not flat, or when it is too large.

This invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for checking a document, comprising:
identifying all nouns and noun phrases in a portion of the document; and
checking that the first occurrence of each noun or noun phrases has proper antecedent basis.

2. The method of claim 1, wherein the portion comprises a claim section.

3. The method of claim 1, wherein the portion comprises a description section.

4. The method of claim 4, comprising identifying each reference number associated with each noun or noun phrases.

5. The method of claim 4, comprising checking that each noun or noun phrases refers to a unique reference number.

6. The method of claim 1, comprising checking that each reference number is shown in one or more drawings.

7. The method of claim 1, wherein the document is a patent document.

8. The method of claim 1, comprising:
a. searching and downloading prior art over a wide area network, the prior art having corresponding sub-parts;
b. separating the downloaded prior art into corresponding prior art sub-parts; and
c. displaying a user interface to receive each IP sub-part and displaying the corresponding prior art sub-part as an example

9. The method of claim 1, comprising filing the document with an agency over the Internet.

10. The method of claim 1, wherein the agency is one of: a patent office and a security exchange commission.

11. An intellectual property (IP) application generator, comprising:
means for identifying all nouns and noun phrases in a portion of the document; and
means for checking that the first occurrence of each noun or noun phrases has proper antecedent basis.

12. The generator of claim 11, wherein the portion comprises a claim section.

13. The generator of claim 11, wherein the portion comprises a description section.

14. The generator of claim 14, comprising means for identifying each reference number associated with each noun or noun phrases.

15. The generator of claim 14, comprising means for checking that each noun or noun phrases refers to a unique reference number.

16. The generator of claim 11, comprising means for checking that each reference number is shown in one or more drawings.

17. The generator of claim 11, comprising:
a. searching and downloading prior art over a wide area network, the prior art having corresponding sub-parts;
b. separating the downloaded prior art into corresponding prior art sub-parts; and
c. displaying a user interface to receive each IP sub-part and displaying the corresponding prior art sub-part as an example

18. The generator of claim 11, comprising filing the document with an agency over the Internet.

19. The generator of claim 11, wherein the agency is one of: a patent office and a security exchange commission.

20. An intellectual property (IP) application generation software, comprising code to:
search for prior art, each prior art having one or more sections, the search engine storing prior art data in a data structure;
parse coupled to the data structure to separate the prior art data into its respective sections;
receive data for a new IP application, the user interface having an example coupled to the parser to receive display;
identify all nouns and noun phrases in a portion of the document; and
check that the first occurrence of each noun or noun phrases has proper antecedent basis;
